(19) United States
(12) Patent Application Publication
(10) Pub. No.: US 2013/0303668 A1
(43) Pub. Date: Nov. 14, 2013

(54) AN OZONE-RESISTANT POLYURETHANE COMPOSITION AND ASSOCIATED METHOD OF PRODUCTION

(71) Applicants: Il Joong Yoon, Seoul (KR); In Jeon, Gyeonggi-do (KR); Og Ryang Wi, Daejeon-Si (KR); Cheol-Jong Park, Daejeon-Si (KR); Yeon-Jo Hong, Daegu-Si (KR)

(72) Inventors: Il Joong Yoon, Seoul (KR); In Jeon, Gyeonggi-do (KR); Og Ryang Wi, Daejeon-Si (KR); Cheol-Jong Park, Daejeon-Si (KR); Yeon-Jo Hong, Daegu-Si (KR)

(73) Assignees: HK VALVE CO., LTD, Gyeonggi-Do (KR); KOREA WATER RESOURCES CORPORATION, Daejeon (KR)

(21) Appl. No.: 13/988,544

(22) PCT Filed: Nov. 10, 2011
(86) PCT No.: PCT/KR11/08531

§ 371 Date: Jul. 31, 2013

(30) Foreign Application Priority Data
Nov. 22, 2010 (KR) 10-2010-0116033

(51) Int. Cl. C08K 5/3475; C08K 5/07

(52) U.S. Cl. CPC C08K 5/3475; C08K 5/07
USPC 524/91; 524/359

(57) ABSTRACT

The ozone-resistant polyurethane composition according to the present invention, which is for the linings of valves, pipes or ozone contactors used in advanced water-treatment plants, comprises: 100 parts by weight of a polyurethane prepolymer consisting of toluene diisocyanate and poly(tetramethylene ether)glycol; from 8 to 14 parts by weight of 6-methyl-2,4-bis(methylthio)phenylene-1,3-diamine; and from 0.8 to 2.8 parts by weight of benzophenone or benzotriazole. Also, the production method for the ozone-resistant polyurethane composition according to the present invention, which is for the linings of valves, pipes or ozone contactors used in advanced water treatment plants, comprises the steps of: mixing from 0.8 to 2.8 parts by weight of benzophenone or benzotriazole in 100 parts by weight of a polyurethane prepolymer consisting of toluene diisocyanate and poly(tetramethylene ether)glycol, and stirring for between 25 and 35 minutes at between 90 and 100° C.; and mixing from 8 to 14 parts by weight of 6-methyl-2,4-bis(methylthio)phenylene-1,3-diamine into the stirred liquid.

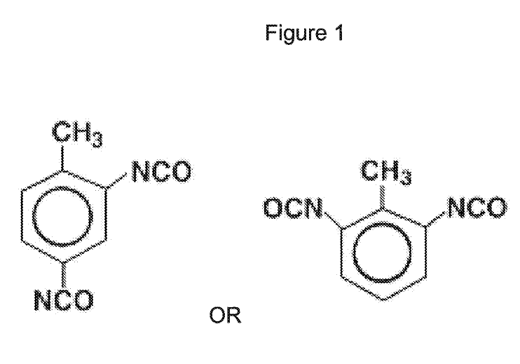

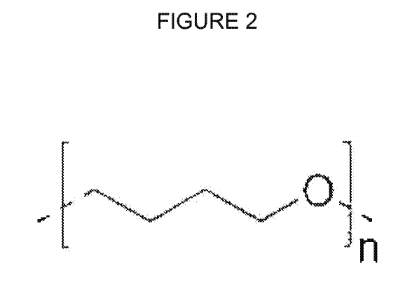

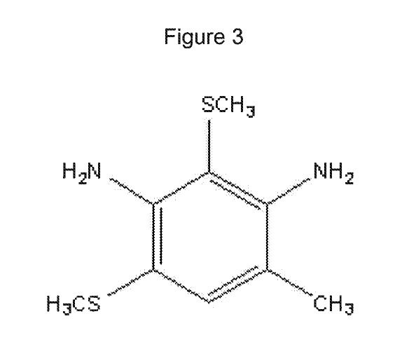

### BACKGROUND OF THE INVENTION

This invention relates to a polyurethane composition. More specifically, this invention relates to an ozone-resistant polyurethane composition which can be used as a lining material for corrosion protection or sealing of various valves in the ozone processing lines of advanced water treatment plants, an inner coating material to prevent inner corrosion of pipes, or corrosion protection material or a cushion seat in an ozone contactor, and the production method thereof.

Advanced water treatment plants use ozone (O₃) as a means of water disinfection. Ozone is a strong oxidizing agent. Parts such as valves, pipes and ozone contactors used in an ozone processing line require surface treatment with an ozone resistant material, especially with materials which provide corrosion protection from the ozone.

Ozone consists of three oxygen atoms, is a powerful oxidant next to fluorine, and has properties such as sterilization, deodorization, discoloration, and strong reactivity with organic or inorganic materials. Because of Ozone's strong oxidizing power it is a strong sterilizing agent and it does not leave residual material after sterilization that is secondary pollution. Therefore ozone is used in many application fields including advance water treatment plants.

When ozone is dissolved in water, it is referred to as ozonated water. The half life of ozonated water is very short, on the order of about 25 minutes. Therefore ozonated water is used for sterilization in advanced water treatment plants, prevention of putrefaction in food processing lines, polluted water treatment, waste water treatment, and night soil treatment. Most advanced water treatment plants include an ozone disinfection process.

The strong oxidizing power of ozone carries out fast oxidization or corrosion as well as sterilization. Ozone-resistant materials should be used in the facilities that use ozone because such oxidizing power of ozone causes corrosion of such facilities. The ozone-resistant materials known include metals such as stainless steel, brass, pig iron, plastics such as polyvinyl chloride (PVC) and Teflon, and synthetic rubbers such as polyethylene (PE), and ethylene propylene.

As demand for the use of ozone increases, the related facilities are also diversifying and there is activity for development of materials for these facilities. A typical example of a material used for parts of an ozone water facility is rubber. However, the strength of rubber is degraded by ozone. Rubber has been used as a sealing material because of its elasticity. Polyurethane has elasticity properties which make it an appropriate substitute for rubber. Polyurethane is generally known to have strong resistance to ozone based on experiments involving air.

The units for ozone concentration are ppm, g/m³, and mg/l. The unit ppm is frequently used. The unit ppm represents a ratio of quantities. There is a great difference between 1 ppm of ozone in ozonated water and one ppm in air. A one ppm ozone concentration in ozonated water means one ozone molecule per one million water molecules, and one ppm of ozone in the air means 1 ozone molecule per one million air molecules. The difference in density between water and the air is about a factor of one 1,000. Considering that the difference between the average molecular weights of water and air, the volume of one million air molecules is about 1,600 times that of one million air molecules. Therefore, assuming the same volume, the number of ozone molecules in one ppm of ozonated water is about 1,300 to 1,500 times that of the gas phase, depending on temperature and pressure.

The present invention discloses the development of an ozone-resistant polyurethane composition with strong corrosion protection (resistance) even in the presence of a high concentration of ozonated water. The concentration of ozone in the ozonated water used in the treatment of drinking water usually ranges from one ppm to two ppm, but the polyurethane composition does not exhibit changes in hardness, melting properties, or cracking even when the ozone concentration is as high as 8 ppm.

### OBJECTS OF THE INVENTION

It is an object of the present invention is to provide new ozone-resistant polyurethane composition.

It is a further object of the invention to provide polyurethane composition with good ozone resistance at ozone water with about 8 ppm of ozone concentration.

It is a still further object of the invention to provide polyurethane composition with good durability with regard to such properties as hardness, melting, and crack at ozone water with about 8 ppm of ozone concentration.

It is a still further object of the invention to provide polyurethane composition which can be used for lining, sealing, cushion, and corrosion protection material for water supply and drainage facilities including valves and pipes.

It is a still further object of the invention to provide a method for preparing said ozone-resistant polyurethane composition.

The above and other objects are attained by the invention particularly described herein.

### SUMMARY OF THE INVENTION

An ozone resistant polyurethane composition suitable for use in linings of valves, pipes, or ozone contactors in an advanced water treatment plant according to the present invention comprises: a polyurethane prepolymer consisting of toluene diisocyanate represented by the following formula (1), and polytetramethylene ether glycol represented by the following formula (2), 100 parts by weight; 6-methyl-2,4-bis(methylthio)phenylene-1,3-diamine represented by the following formula (3), 8 to 14 parts by weight; and benzophenone or benzotriazole, 0.8 to 2.8 parts by weight.

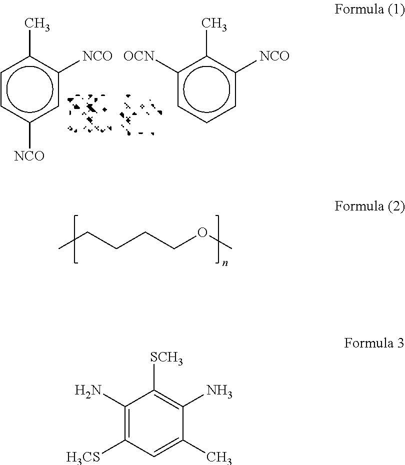

The method for manufacturing the ozone-resistant polyurethane composition used in the linings of valves, pipes or ozone contactors comprises the steps of:

mixing a polyurethane prepolymer consisting of toluene diisocyanate represented by the formula 1 and polytetramethylene ether glycol 100 parts by weight and benzophenone or benzotriazole 0.8 to 2.8 parts by weight, and stiffing 25 to 35 minutes at 90-100° C.; and

mixing 6-methyl-2,4-bis(methylthio)phenylene-1,3-the diamine represented by said formula 3, 8 to 14 parts by weight with said stirred solution.

It takes about 5 minutes for the curing of the polyurethane composition manufactured by the said method and about 12 hours for it to attain maximum hardness.

The details of the present invention are described in detail below.

### EFFECT OF THE INVENTION

The present invention has the effect of providing an ozone resistant polyurethane composition having good durability with regard to such properties as hardness, melting, and cracking at ozone water with about 8 ppm of ozone concentration and usable as material for the linings, sealing, cushion, and corrosion protection of facilities such as various valves, pipes, or ozone contactors at advanced water treatment plant.

Therefore, the present invention provides the effect of maximizing the life of various facilities used in the ozone treatment lines by protecting them from the strong oxidizing power of the ozone water.

### DETAILED DESCRIPTION OF THE INVENTION

The present invention is an ozone resistant polyurethane composition usable as material for the linings of various valves or for the sealing, cushioning, and corrosion protection in an advanced water treatment plant.

Polyurethane is a polymer with excellent durability, chemical resistance, and drying properties, having as an advantage that it can be synthesized in various forms such as a flexible foam, a rigid foam, paints, plastics, a rubber, adhesives, a fiber, sealants, elastomers, etc. Thus much attention is given to it commercially as well as industrially. Polyurethane is a chemical compound with a urethane bond (—NH—CO—O—). The urethane bond is generated by the reaction of a highly reactive isocyanate group (—NCO) and hydroxyl (—OH) group containing activated carbon. Here, the structure other than the urethane bond can be selected by the type and combination of isocyanate and polyol. Products for various purposes can be produced depending on what structure is combined.

Polyurethane elastomer (PU elastomer) is a copolymer in which a soft segment with a glass transition temperature (Tg) lower than room temperature and a hard segment with a Tg higher than room temperature are continuously connected. Phase separation occurs microscopically because these two blocks do not melt each other and a domain is formed. The hard segment acts as a bridge to inhibit the fluidity of the soft segment and behavior as found in rubber is exhibited. The soft segment in the elastomer is a linear polymer chain such as a polyester or a polyether and the hard segment is a solid compound such as a urethane group or a urea group. Recently, increased attention has been given to the mutual influence and stability by phase separation of these two blocks.

In one embodiment said ozone resistant polyurethane composition comprises: the polyurethane prepolymer consisting of toluene diisocyanate represented by the following formula (1) and polytetramethylene ether glycol represented by the following formula (2), 100 parts by weight;

6-methyl-2,4-bis(methylthio)phenylene-1,3-diamine as a sulfur containing amine curing agent, 8 to 14 parts by weight; and benzophenone or benzotriazole as a UV stabilizer, 0.8 to 2.8 parts by weight.

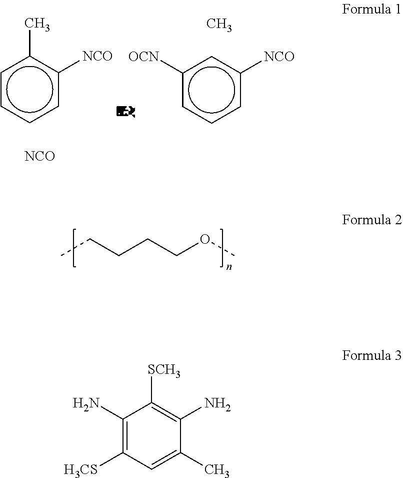

The method for manufacturing said ozone-resistant polyurethane composition comprises the steps of:

mixing 100 parts by weight of polyurethane prepolymer consisting of toluene diisocyanate represented by Formula (1) and polytetramethylene ether glycol represented by Formula (2), and 0.8 to 2.8 parts by weight of benzophenone or benzotriazole, and stiffing the mixture for 25 to 35 minutes at 90-100° C.; and mixing 8 to 14 parts by weight of 6-methyl-2,4-bis(methylthio)phenylene-1,3-diamine represented by Formula 3 with the stirred solution.

Said polyurethane prepolymer is manufactured by putting polyol in the reactor which can control temperature and speed, adding isocyanate and reacting 4 to 5 hours while stirring, and terminating the reaction when the free NCO group content reaches the theoretical level.

A commercially available curing agent may be used for said sulfur containing amine curing agent, but 6-methyl-2,4-bis(methylthio)phenylene-1,3-diamine represented by Formula (3) is preferable. Also, benzophenon or benzotriazole is preferable for use as a UV-stabilizer.

It takes about 5 minutes for the curing of the polyurethane composition manufactured by the said method and about 12 hours for it to attain maximum hardness.

Said sulfur containing amine curing agent at 8 to 14 parts by weight is used for 100 parts by weight of said polyurethane prepolymer in embodiments of the present invention.

If less than 8 parts by weight of said sulfur containing amine curing agent is put in for 100 parts by weight of said polyurethane prepolymer, insufficient curing will be attained and if more than 14 parts by weight of said sulfur containing amine curing agent is put in for 100 parts by weight of said polyurethane prepolymer, then there will be a sharp decrease in elasticity because of over-hardening.

The quantity of said sulfur containing amine curing agent mixed with said polyurethane prepolymer will vary according to the purpose of the present invention. If low hardness and high elasticity are needed, it is preferable to put in said sulfur containing amine curing agent at 8 to 11 parts by weight, and if low elasticity and high hardness is needed, it is preferable to put in said sulfur containing amine curing agent at 11 to 12 parts by weight. In the present invention, it is preferable to include a UV stabilizer at 2.8 parts by weight for said polyurethane prepolymer at 100 parts by weight. The optimal composition of UV stabilizer was realized according to following example embodiment according to the present invention.

The present invention will be described more by the following embodiments, which are shown for the purpose of illustrating the invention, not for limiting the scope of the invention.

### EXAMPLES

Shinseong Chemical Co.'s model NT-90 was used for said polyurethane prepolymer. The French company Baule's model XL-1705 was used for said sulfur containing amine curing agent which has the structure of said formula (3) with gram equivalent weight 107, boiling point 353° C., density 1.21 g/cc at room temperature, viscosity 690 at room temperature, amine number 536 mg·KOH/g, TDA contents less than 1.0% by weight. Baule's product was used for said UV stabilizer.

### Examples 1A-1D

As shown in Table 1 below, material properties were measured by adding said sulfur containing amine curing agent at 11 parts by weight per 100 parts by weight of said polyurethane prepolymer, and changing the input quantity of said UV stabilizer from 2 to 8 parts by weight. Hardness was measured before the testing and at the passing of 150, 300, and 500 hours. Hardness, melting, and crack resistant properties were observed. The results of the measurements of the properties are shown together in table 1.

TABLE 1

| | Component | | | Hardness | | | | | | | | | | |
|---|---|---|---|---|---|---|---|---|---|---|---|---|---|---|
| | 1. | 2. Curing | 3. | Before | 150 hours | | | 300 hours | | | 500 hours | | | |
| Example | NT-90 | Agent | UV Stabilizer | Testing | H¹ | M² | C³ | H¹ | M² | C³ | H¹ | M² | C³ | Pass |
| 1A | 100 | 11 | 2 | 87 | 87 | 0 | 0 | 86 | 0 | 0 | 86 | 0 | 0 | Yes |
| 1B | 100 | 11 | 4 | 86 | 85 | 0 | 0 | 85 | 0 | 0 | 84 | 1 | 0 | No |
| 1C | 100 | 11 | 6 | 86 | 85 | 0 | 0 | 85 | 0 | 0 | 84 | 1 | 0 | No |
| 1D | 100 | 11 | 8 | 85 | 84 | 0 | 0 | 83 | 0 | 0 | 83 | 1 | 1 | No |

¹H: Hardness,
²M: Melting
³C: Crack
* Melting: 0 (No), 1 (Appeared), 2 (A Little), 3 (Medium), 4 (Much), 5 (Very Much)
* Crack: 0 (No), 1 (Appeared), 2 (A Little), 3 (Medium), 4 (Much), 5 (Very Much)
* Pass: Yes, if hardness change less than 1, no melting, and no crack.
No, if hardness change more than 2, melting, or crack

Only example 1A which used the third component UV stabilizer at 2 parts by weight was preferable and other examples were not, as shown in Table 1.

### Example 2A-2M

As shown in the Table 2, below, material properties were measured by adding said sulfur containing amine curing agent at 11 parts by weight per 100 parts by weight of said polyurethane prepolymer, and changing the input quantity of said UV stabilizer from 0.6 to 3.0 parts by weight. The results of the measurements of the properties are shown together in Table 2.

TABLE 2

| | Component | | | Hardness | | | | | | | | | | |
|---|---|---|---|---|---|---|---|---|---|---|---|---|---|---|
| | 1. | 2. Curing | 3. | Before | 150 hours | | | 300 hours | | | 500 hours | | | |
| Example | NT-90 | Agent | UV Stabilizer | Testing | H¹ | M² | C³ | H¹ | M² | C³ | H¹ | M² | C³ | Pass |
| 2A | 100 | 11 | 0.6 | 87 | 86 | 0 | 0 | 85 | 0 | 0 | 85 | 0 | 0 | No |
| 2B | 100 | 11 | 0.8 | 86 | 86 | 0 | 0 | 85 | 0 | 0 | 85 | 0 | 0 | Yes |
| 2C | 100 | 11 | 1.0 | 87 | 87 | 0 | 0 | 86 | 0 | 0 | 86 | 0 | 0 | Yes |
| 2D | 100 | 11 | 1.2 | 87 | 87 | 0 | 0 | 87 | 0 | 0 | 86 | 0 | 0 | Yes |
| 2E | 100 | 11 | 1.4 | 86 | 86 | 0 | 0 | 86 | 0 | 0 | 86 | 0 | 0 | Best |
| 2F | 100 | 11 | 1.6 | 87 | 87 | 0 | 0 | 87 | 0 | 0 | 87 | 0 | 0 | Best |
| 2G | 100 | 11 | 1.8 | 86 | 86 | 0 | 0 | 86 | 0 | 0 | 85 | 0 | 0 | Yes |
| 2H | 100 | 11 | 2 | 87 | 87 | 0 | 0 | 86 | 0 | 0 | 86 | 0 | 0 | Yes |
| 2I | 100 | 11 | 2.2 | 87 | 87 | 0 | 0 | 86 | 0 | 0 | 86 | 0 | 0 | Yes |
| 2J | 100 | 11 | 2.4 | 86 | 86 | 0 | 0 | 85 | 0 | 0 | 85 | 0 | 0 | Yes |
| 2K | 100 | 11 | 2.6 | 87 | 87 | 0 | 0 | 86 | 0 | 0 | 86 | 0 | 0 | Yes |
| 2L | 100 | 11 | 2.8 | 87 | 87 | 0 | 0 | 86 | 0 | 0 | 86 | 0 | 0 | Yes |
| 2M | 100 | 11 | 3.0 | 86 | 85 | 0 | 0 | 85 | 0 | 0 | 84 | 1 | 0 | No |

¹H: Hardness),
²M: Melting
³C: Crack
* Melting: 0 (No), 1 (Appeared), 2 (A Little), 3 (Medium), 4 (Much), 5 (Very Much)
* Crack: 0 (No), 1 (Appeared), 2 (A Little), 3 (Medium), 4 (Much), 5 (Very Much)
* Pass: Yes, if hardness change less than 1, no melting, and no crack.
No, if hardness change more than 2, melting, or crack

All the examples which used UV stabilizer at from 0.8 to 2.8 parts by weight (2B-2L) were preferable except for the example 2A which used the third component UV stabilizer at less than 0.8 parts by weight, and 2M which used it at more than 2.8 parts by weight as shown in Table 2. Especially, the cases with UV stabilizer input of 1.4 and 1.6 parts by weight were most preferable.

The ozonated water test results in the above embodiment examples were measured with an ozone water test device. The ozone water test device consisted of an ozone generator, an ozone mixer, an ozone testing tank, and a concentration meter. The ozone water concentration was 8.0±0.5 ppm, the ozone water input quantity was 3.0±0.2 l/min, and the ozonated water temperature ranged between 10 and 20° C. The total testing time was 500 hours. The measurements were conducted at the time points of 150, 300, and 500 hours. The test parameters measured were hardness, degree of surface melting (melting), and degree of surface cracking (crack).

The invention is subject to various modifications and variations which can be practiced by a person of ordinary skill in the art, and all fall within the scope of the claimed concept.

What is claimed:

1. An ozone resistant polyurethane composition used for linings of valves, pipes, or ozone contactors at advanced water treatment plant, which comprises:
100 parts by weight of a polyurethane prepolymer comprising toluene diisocyanate represented by Formula (1) and polytetramethylene ether glycol represented by Formula (2);
8 to 14 parts by weight of 6-methyl-2,4-bis(methylthio)phenylene-1,3-diamine represented by Formula (3); and
0.8 to 2.8 parts by weight of benzophenone or benzotriazole:

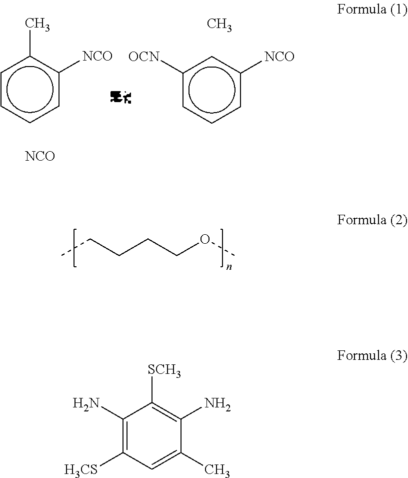

2. A method for preparing an ozone-resistant polyurethane composition for use of linings of valves, pipes or ozone contactors at advanced water treatment plant, which comprises the steps of:
mixing 100 parts by weight of polyurethane prepolymer comprising toluene diisocyanate represented by Formula (1) and polytetramethylene ether glycol represented by Formula (2) with 0.8 to 2.8 parts by weight of benzophenone or benzotriazole, and stirring the mixture for 25 to 35 minutes at 90-100° C; and
mixing 8 to 14 parts by weight of 6-methyl-2,4-bis(methylthio)phenylene-1,3-the diamine represented by Formula (3) with the mixture [chemical structure]
